(19) United States
(12) Patent Application Publication
(10) Pub. No.: US 2002/0125770 A1
(43) Pub. Date: Sep. 12, 2002

(54) Method and system for monitoring a brake system of a vehicle

(76) Inventors: Ulrich Hessmert, Schwieberdingen (DE); Jost Brachert, Ditzingen (DE); Thomas Sauter, Remseck (DE); Helmut Wandel, Markgroeningen (DE); Norbert Polzin, Zaberfeld (DE)

Correspondence Address: KENYON & KENYON, ONE BROADWAY, NEW YORK, NY, 10004, US

(21) Appl. No.: 10/034,144

(22) Filed: Dec. 28, 2001

(30) Foreign Application Priority Data
Dec. 30, 2000 (DE) 1 00 65 757.5

(51) Int. Cl. B60T 8/32

(52) U.S. Cl. 303/191

(57) ABSTRACT

A method and a system for monitoring a brake system of a vehicle, in which braking and driving forces of a vehicle are measured at each wheel of the vehicle using sensors that measure the forces acting between the vehicle wheel and the road, and in which the measured braking forces are compared with one another and/or with predefined braking forces stored in a memory unit, and, if predefined differences between measured braking forces and/or a measured braking force and a predefined braking force are exceeded, it is inferred that a brake problem has arisen in the brake system.

### FIELD OF THE INVENTION

The present invention relates to a method and a system for monitoring a brake system of a vehicle.

### BACKGROUND INFORMATION

It is believed that there are methods for monitoring brake systems of vehicles that provide regulation of the brake pressure as a function of statuses between the road and the wheels on the vehicle that are derived from wheel speed signals. In particular, methods for monitoring and regulating brake systems of vehicles include, for example, ABS or ABSR regulating systems.

It is believed that a method and/or system was not previously available to directly determine the forces acting between the wheel and the road because there were no sensors suitable for this. Instead, the signals required for regulating were derived and calculated from wheel speed signals. It is believed, however, that there may be sensors with which it is possible to directly determine the status between the road and the vehicle wheels.

The reference of Stoecker, Joerg et al., Der “Intelligente Reifen”—Zwischenergebnisse einer interdisziplinären Forschungskooperation. [The “Intelligent Tire”: Interim Results of an Interdisciplinary Cooperative Research Project], in ATZ Automobiltechnische Zeitschrift 97, 1995, 12, pages 824-832, for example, refers to a tire that may be equipped with an integrated force sensor with which it is possible to determine forces acting on the tire in three directions, namely the longitudinal or x-direction, the transverse or y-direction, and the vertical or z-direction. The signals derived from the forces that are detected may be sent to an evaluation unit in which the signals are evaluated as desired. A further device for determining the rotational behavior of a vehicle wheel is referred to, for example, in German Patent Published Application No. 196 20 581.

With such tire sensors, braking and driving forces that arise between the wheels of a vehicle and the road can be determined directly. This may have the advantage that in the case of regulating the driving behavior of a vehicle it is no longer necessary to carry out extensive calculations for further use that may conceivably supply imprecise results regarding the braking and driving forces.

Thus, for example, German Patent Application 197 44 725 refers to state variables of a motor vehicle being determined based on the forces acting on the individual wheels, which are determined using tire sensors. The state variables that have been determined may then be corrected.

Although tire sensors have been referred to as being useful for regulating the driving behavior of vehicles, it is believed that it has not been known that signals from these sensors may be used in a targeted manner to monitor and regulate a vehicle's brake system.

In view of the foregoing and starting from the above methods for using tire sensors to detect variables relevant to brake system regulation, as is referred to in, for example, Stoecker, Joerg et al., The “Intelligent Tire”: Interim Results of an Interdisciplinary Cooperative Research Project, in ATZ Automobiltechnische Zeitschrift 97, 1995, 12, pages 824-832, it is believed that there is a need for a method and a system for monitoring a brake system of a vehicle using sensors which measure the forces acting between the vehicle wheel and the road.

### SUMMARY OF THE INVENTION

According to the exemplary embodiment and/or exemplary method of the present invention, sensors are used to measure the forces acting between the vehicle wheel and the road and signals for braking forces that are measured directly during movement of the vehicle are compared with one another or with predefined values, so as to infer that a problem is present in the brake system if the result of the comparison exceeds a predefined limit value that is stored in a memory unit.

In particular, measured braking forces of the same brake circuit or of different brake circuits may be compared with one another. Herein, required brake pressure differences such as those that arise between the front wheels and the rear wheels are taken into account in that they are taken into account via a weighting using a signal supplied by the memory unit.

It is believed to be advantageous that the braking force distribution may be monitored via comparison of the signals for braking forces obtained via measurement with predefined brake pressure distributions that may be predefined in a memory unit, and via plausibility checks.

If it is decided that a problem is present, a warning may be output to the driver and/or the erroneous brake pressure may be corrected.

Not only the foot brake functioning but also handbrake functioning may be monitored, in the case of monitoring of the handbrake functioning movement of the vehicle wheels being required, and it being concluded that there is a problem with handbrake functioning if, when the measured braking forces are compared, it is determined that the handbrake is applied asymmetrically.

A system for monitoring a brake system has sensors via which signals for braking forces may be obtained, these providing information regarding the frictional connection between the road and the vehicle wheel during movement of the vehicle wheels. The signals are sent to a comparison unit in which the signals are compared with one another or with predefined values from a memory unit. If the result of the comparison exceeds a difference from the memory unit that is predefined as a limit value, a signal is sent to a warning unit to inform the driver regarding the problem that has been detected. Simultaneously a signal may be sent to a regulating unit so as to perform regulating so that the problem that has been detected is compensated for in the brake system via modification of the brake pressure.

Using the exemplary method for monitoring a vehicle brake systems, the general status of the brake system may be determined and taken into account so as to improve vehicle safety and ABSR regulation. With the help of the forces that are measured, braking force distribution may be checked, and functioning may be improved by correcting the brake pressures that are predefined by the logic systems. Deterioration in the functioning of a brake lining or an incorrect brake status is detectable. Brake failure is also detectable.

### BRIEF DESCRIPTION OF THE DRAWING

FIG. 1 shows a block diagram of an exemplary system according to the present invention for monitoring a brake system for vehicles, by which the exemplary method according to the present invention may be carried out or performed using this system.

### DETAILED DESCRIPTION

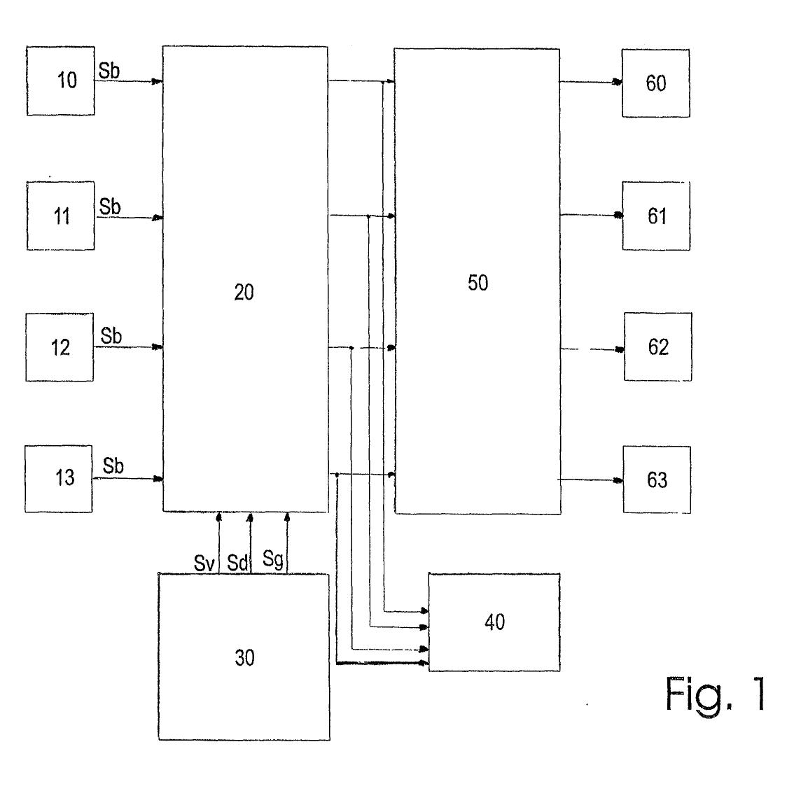

FIG. 1 is a block diagram of a system for monitoring a brake system of a vehicle. sensors 10, 11, 12, and 13 for four vehicle wheels obtain signals Sb for braking forces which provide information regarding the status between the road and the vehicle. Signals Sb for the braking forces that arise at the vehicle wheels are sent to a comparison unit 20, to which signals Sv, Sd and Sg may also be sent simultaneously by a memory unit 30. In the description below signals Sv, Sd and Sg will be described in detail. It is important to note that signals Sv, Sd and Sg may each have a plurality of signals having different values for the various vehicle wheels.

In comparison unit 20, signals Sb for the braking forces arising at the vehicle wheels are compared with one another or with signals Sv for predefined values from memory unit 30. If signals Sb for the braking forces arising at the vehicle wheels are compared with one another, the differing requirements with regard to brake pressures at the different vehicle wheels, i.e. front and rear, are taken into account in the comparison, in that appropriate weightings are carried out via the predefined signals Sg supplied by memory unit 30. If measured signals Sb are compared with predefined values Sv, this weighting step is not required.

If a given comparison reveals a signal difference that exceeds a difference limit value signal Sd supplied by memory unit 30, it is inferred that a problem has arisen in the brake system.

If signals Sb for the braking forces arising at the vehicle wheels are compared with predefined values Sv, a decision in comparison unit 20 that a problem is present is an indication that the braking force distribution is erroneous.

If it is decided in comparison unit 20 that a problem is present, a warning signal is output to a warning unit 40, which informs the driver about the brake system's problem status. Simultaneously a signal may be sent to a regulating unit 50, which carries out a regulation so as to compensate for the erroneous brake pressure. Regulating unit 50 is then able to send signals to brake devices 60, 61, 62, and 63 for the individual vehicle wheels.

It is important to note that the system shown may be used not only to monitor the functioning of the foot brake but also to monitor the functioning of the handbrake. Herein, the vehicle wheels must be moving, which means that monitoring of the functioning of the handbrake may be carried out during (slow) driving or on a roller test rig. During monitoring, in comparison unit 20 the braking forces that have been measured are checked for symmetry. Monitoring may be used to determine the instantaneous efficacy of the handbrake, and if it is decided in comparison unit 20 that a problem is present, it may be inferred that the coefficient of friction between the brake lining and the brake disc has undergone functional deterioration.

A method and a system for monitoring a brake system of a vehicle are described above. Monitoring is carried out on an ongoing basis during a driving/braking procedure. Brake circuit failure may be detected by comparing the braking forces that are measured. Problems in other devices in the brake system, e.g. the pressure-reducing valve or the master cylinder, may also be inferred. Furthermore, a reduction in the brake disc/brake lining coefficient of friction combination, loss of pressure at a wheel, etc. may also be determined by monitoring the brake system.

It is believed that ABSR regulation in regulating unit 50 may be significantly improved by measuring the braking and driving forces using sensors that allow conclusions to be drawn regarding the status of the road surface.

What is claimed is:

1. A method for monitoring a brake system of a vehicle during movement of vehicle wheels, the method comprising:
monitoring braking forces and driving forces of a vehicle at the vehicle wheels of the vehicle using sensors to measure forces acting between the vehicle wheels and the road, wherein the monitoring includes:
comparing signals for measured braking forces with at least one of one another and with signals for predefined braking forces stored in a memory unit, and
inferring that a problem has arisen in the brake system if predetermined difference limit value signals stored in the memory unit are exceeded, the predetermined difference limit value signals being between at least one of the signals for the measured braking forces and at least one of the signals for the predefined braking forces.

2. The method of claim 1, wherein the signals for the measured braking forces of different brake circuits are compared with one another.

3. The method of claim 1, wherein the signals for the measured braking forces of the same brake circuit are compared with one another.

4. The method of claim 1, wherein when the signals for the braking forces arising at the vehicle wheels are compared with one another, differing requirements in terms of brake pressures at different vehicle wheels are taken into account by carrying out appropriate weightings using signals supplied by the memory unit.

5. The method of claim 1, wherein the signals for the measured braking forces are compared with signals stored in the memory unit for braking forces that are one of predefined by logic systems and anticipated, and if a deviation between the signals for the measured braking forces and the signals for the predefined braking forces is determined, it is inferred that there is a problem with a braking force distribution.

6. The method of claim 1, wherein a warning is output to the driver if the problem is in the brake system.

7. The method of claim 1, wherein if the problem is in the brake system, a brake pressure is corrected at the one of the vehicle wheels at which the problem arose.

8. The method of claim 1, wherein functioning of the handbrake and functioning of the foot brake is monitored.

9. A system for monitoring a brake system of a vehicle during movement of vehicle wheels, the system comprising:
sensors to measure signals for braking forces at the vehicle wheels, the braking forces acting between a road and the vehicle wheels being measured using the sensors;
a memory unit to store signals for predefined braking forces and predefined difference limit value signals; and
a comparison unit to at least one of compare the signals for measured braking forces with one another and compare the signals for measured braking forces with the signals for the predefined braking forces, and to infer that there is a problem in the brake system if a difference limit value signal suppliable by the memory unit is exceeded by a comparison result;
wherein the monitoring includes monitoring the braking forces and the driving forces of the vehicle at the vehicle wheels of the vehicle using the sensors to measure forces acting between the vehicle wheels and the road.

10. The system of claim 9, further comprising a warning unit to receive a problem signal if the problem has been inferred, and to report the problem to the driver.

11. The system of claim 9, further comprising a regulating unit to receive a problem signal if the problem has been inferred, and to appropriately regulate brake pressure.

12. The method of claim 4, wherein the different wheels include front wheels and rear wheels.
